(19) United States
(12) Patent Application Publication
(10) Pub. No.: US 2026/0195606 A1
(43) Pub. Date: Jul. 9, 2026

(54) A Method to Detect Poisoning of an AI Model and a System Thereof

(71) Applicants: Robert Bosch GmbH, Stuttgart (DE); Bosch Global Software Technologies Private Limited, Bangalore (IN)

(72) Inventors: Avinash Amballa, Vizianagaram (IN); Manojkumar Somabhai Parmar, Ahmedabad (IN); Govindarajulu Yuvaraj, Bengaluru (IN)

(21) Appl. No.: 19/132,589

(22) PCT Filed: Nov. 29, 2023
(86) PCT No.: PCT/EP2023/083573

§ 371 Date: May 23, 2025

(30) Foreign Application Priority Data
Nov. 29, 2022 (IN) 202241068482

(51) Int. Cl. G06N 3/094; G06N 3/045

(52) U.S. Cl. CPC G06N 3/094; G06N 3/045

(57) ABSTRACT

A method to detect poisoning of an AI model and a system thereof is disclosed. The system includes the trained AI model, a processor and at least two clean AI models. The processor is configured to feed a manipulated dataset as input to the trained AI model and the two clean AI models. The outputs of each of the layers of the trained AI model and the at least two clean AI models are analyzed using Lp norm to detect poisoning of the AI Model.

### FIELD OF THE INVENTION

The present disclosure relates to the field of Artificial Intelligence security. In particular, it proposes a method to detect poisoning of an AI model and a system thereof.

### BACKGROUND OF THE INVENTION

With the advent of data science, data processing and decision making systems are implemented using artificial intelligence modules. The artificial intelligence modules use different techniques like machine learning, neural networks, deep learning etc. Most of the AI based systems, receive large amounts of data and process the data to train AI models. Trained AI models generate output based on the use cases requested by the user. Typically the AI systems are used in the fields of computer vision, speech recognition, natural language processing, audio recognition, healthcare, autonomous driving, manufacturing, robotics etc. where they process data to generate required output based on certain rules/intelligence acquired through training.

To process the inputs and give a desired output, the AI systems use various models/algorithms which are trained using the training data. Once the AI system is trained using the training data, the AI systems use the models to analyze the real time data and generate appropriate result. The models may be fine-tuned in real-time based on the results. The models in the AI systems form the core of the system. Lots of effort, resources (tangible and intangible), and knowledge goes into developing these models.

It is possible that some adversary may try to tamper/manipulate/evade the model in AI Systems to create incorrect outputs. The adversary may use different techniques to manipulate the output of the model. One of the simplest techniques used by the adversary is where the adversary sends queries to the AI system using his own test data to compute or approximate the gradients through the model. Based on these gradients, the adversary can then manipulate the input in order to manipulate the output of the Model. Another technique is wherein the adversary may manipulate the input data to bring an artificial output. In this invention we focus on poisoning. Adversarial data poisoning is defined as an effective attack against machine learning and threatens model integrity by introducing poisoned data into the training dataset. Since the model learns on poisoned dataset, it is bound to give incorrect results.

This will cause hardships to the original developer of the AI in the form of business disadvantages, loss of confidential information, loss of lead time spent in development, loss of intellectual properties, loss of future revenues etc. Data poisoning can render machine learning models inaccurate, possibly resulting in poor decisions based on faulty outputs. Hence there is a need for a method of detection of AI poisoning.

### BRIEF DESCRIPTION OF THE ACCOMPANYING DRAWINGS

An embodiment of the invention is described with reference to the following accompanying drawings:

FIG. 1 depicts a system to detect poisoning of a trained AI Model;

FIG. 2 illustrates method steps to detect poisoning of a trained AI Model.

### DETAILED DESCRIPTION OF THE DRAWINGS

It is important to understand some aspects of artificial intelligence (AI) technology and artificial intelligence (AI) based systems or artificial intelligence (AI) system. Some important aspects of the AI technology and AI systems can be explained as follows. Depending on the architecture of the implements AI systems may include many components. One such component is an AI module. An AI module with reference to this disclosure can be explained as a component which runs a model.

A model can be defined as reference or an inference set of data, which is use different forms of correlation matrices. Using these models and the data from these models, correlations can be established between different types of data to arrive at some logical understanding of the data. A person skilled in the art would be aware of the different types of AI models such as linear regression, naïve bayes classifier, support vector machine, neural networks and the like. It must be understood that this disclosure is not specific to the type of model being executed in the AI module and can be applied to any AI module irrespective of the AI model being executed. A person skilled in the art will also appreciate that the AI module may be implemented as a set of software instructions, combination of software and hardware or any combination of the same.

Some of the typical tasks performed by AI systems are classification, clustering, regression etc. Majority of classification tasks depend upon labeled datasets; that is, the data sets are labelled manually in order for a neural network to learn the correlation between labels and data. This is known as supervised learning. Some of the typical applications of classifications are: face recognition, object identification, gesture recognition, voice recognition etc. In a regression task, the model is trained based on labeled datasets, where the target labels are numeric values. Some of the typical applications of regressions are: Weather forecasting, Stock price predictions, House price estimation, energy consumption forecasting etc. Clustering or grouping is the detection of similarities in the inputs. The cluster learning techniques do not require labels to detect similarities. Learning without labels is called unsupervised learning. Unlabeled data is the majority of data in the world.

As the AI module forms the core of the AI system, the module needs to be protected against attacks. AI adversarial threats can be largely categorized into-model extraction attacks, inference attacks, evasion attacks, and data poisoning attacks. Inference attacks attempt to infer the training data from the corresponding output or other information leaked by the target model. Studies have shown that it is possible to recover training data associated with arbitrary model output. Ability to extract this data further possess data privacy issues. Evasion attacks are the most prevalent kind of attack that may occur during AI system operations. In this method, the attacker works on the AI algorithm's inputs to find small perturbations leading to large modifications of its outputs (e.g., decision errors) which leads to evasion of the AI model. In poisoning attacks, the adversarial carefully inject crafted data to contaminate the training data which eventually affects the functionality of the AI system.

In Model Extraction Attacks (MEA), the attacker gains information about the model internals through analysis of input, output, and other external information. Stealing such a model reveals the important intellectual properties of the organization and enables the attacker to craft other adversarial attacks such as evasion attacks. This attack is initiated through an attack vector. In the computing technology a vector may be defined as a method in which a malicious code/virus data uses to propagate itself such as to infect a computer, a computer system or a computer network. Similarly, an attack vector is defined a path or means by which a hacker can gain access to a computer or a network in order to deliver a payload or a malicious outcome. A model stealing attack uses a kind of attack vector that can make a digital twin/replica/copy of an AI module.

This invention primarily focuses on detecting whether or not an AI Model is poisoned. The difference between an attack vector that is meant to evade a model's prediction or classification and a poisoning attack is persistence. In poisoning, the attacker's goal is to get their poisoned inputs to be accepted as training data. AI Models are retrained with newly collected data at certain intervals, depending on their intended use. Since poisoning usually happens over time, and over some number of training cycles, it can be hard to tell when prediction accuracy starts to shift.

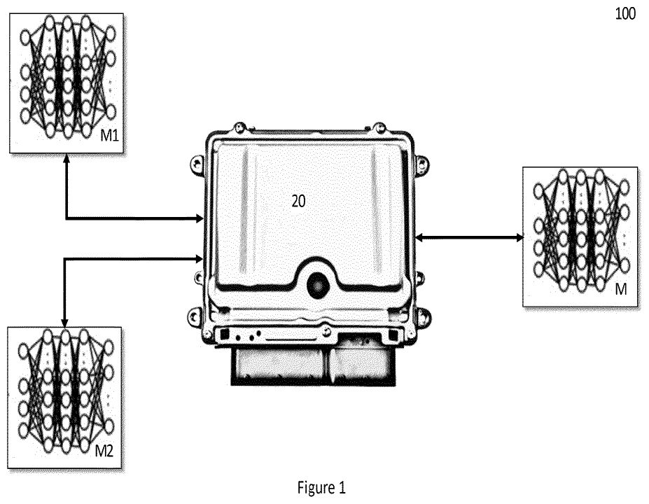

FIG. 1 depicts a system (100) to detect poisoning of a trained AI model (M). The system (100) comprises the trained AI model (M), a processor (20) and at least two clean AI models (M1, M2). The trained AI model (M) is trained on dataset whose integrity can not be ascertained. The two clean AI models (M1, M2) are trained on a non-poisonous dataset i.e. a dataset whose integrity is assured. Further the clean AI models (M1, M2) have the same architecture as the trained AI model (M). This means that the trained AI model (M) and the at least two clean AI models (M1,M2) have the same set of layers. A layer in an AI model is defined as a combination of node and the connection between the nodes.

The system (100) is characterized by the functionality of the processor (20). In an exemplary embodiment of the present invention, the processor (20) may be implemented as any or a combination of: one or more microchips or integrated circuits interconnected using a parent board, hardwired logic, software stored by a memory device and executed by a microprocessor (20), firmware, an application specific integrated circuit (ASIC), and/or a field programmable gate array (FPGA). In an alternate embodiment on the present invention the processor (20) may reside remotely in a cloud.

The processor (20) is configured to: feed a manipulated dataset as input to the trained AI model (M) to get a set of primary outputs for each layer of the AI Model; feed the manipulated dataset as input to the said at least two clean AI models (M1, M2) to get a first set of secondary outputs and a second set of secondary outputs respectively for each layer of the said two clean AI models (M1, M2) respectively; calculate a distance D1 using Lp norm between the first set of secondary outputs and the second set of secondary outputs; calculate a distance D2 using Lp norm between the first set of secondary outputs and the set of primary outputs; calculate a distance D3 using Lp norm between the second set of secondary outputs and the set of primary outputs; perform an analysis on the calculated distances D1, D2, D3 to detect poisoning of the AI Model. The processor (20) is further configured to compute a set ratios for mean of distances (D1,D2, D3) and compare it to a pre-defined threshold to perform the analysis.

As used in this application, the terms model, layer, node and system (100) are intended to refer to a computer-related entity or an entity related to, or that is part of, an operational apparatus with one or more specific functionalities, wherein such entities can be either hardware, a combination of hardware and software, software, or software in execution. The components of the system (100) may communicate via local and/or remote processes such as in accordance with a signal having one or more data packets (e.g., data from one component interacting with another component in a local system, distributed system, and/or across a network such as the Internet with other systems via the signal).

It should be understood at the outset that, although exemplary embodiments are illustrated in the figures and described below, the present disclosure should in no way be limited to the exemplary implementations and techniques illustrated in the drawings and described below.

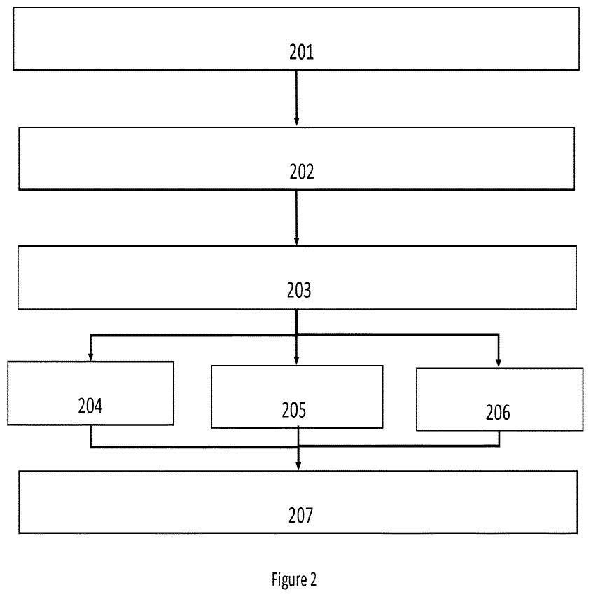

FIG. 2 illustrates method steps (200) to detect poisoning of a trained AI model (M). The method steps (200) are carried out in the system (100) disclosed in accordance with FIG. 1. All components of the system (100) have been explained in accordance with FIG. 1.

Method step 201 comprises training at least two Clean AI models (M1, M2) having the same architecture as the trained AI model (M) using a non-manipulated dataset.

Method step 202 comprises feeding a manipulated dataset as input to the trained AI model (M) by means of the processor (20) to get a set of primary outputs for each layer of the trained AI model (M). Since, poisoned model behaves in the similar fashion as to clean model when given clean input whereas it behaves differently compared to clean models only when given manipulated dataset. The manipulated data can either be fetched from a database or generated by the processor (20). In an exemplary embodiment of the present invention, manipulated dataset is generated by the processor (20) that is similar to poisoned data to distinguish poisoned models from clean models.

Manipulated dataset=alpha*x+(1−alpha)*Gaussian Noise, where alpha=[0,1], x_clean is a clean input dataset and alpha is a randomly selected scaling factor.

For an AI model trained for image classification this can be expressed as lets us assume patched image dataset was used to poison the AI model, then

Patched_img=mask*noisy_input+(1−mask)*Gaussian Noise, where mask can be any random squares with random values.

Method step 203 comprises feeding the manipulated dataset as input to the said at least two clean AI models (M1, M2) by means of the processor (20) to get a first set of secondary outputs and a second set of secondary outputs respectively for each layer of the said two clean AI models (M1, M2).

Method step 204 comprises calculating a distance D1 using Lp norm between the first set of secondary outputs and the second set of secondary outputs by means of the processor (20). In mathematics, the LP spaces are function spaces defined using a natural generalization of the p-norm for finite-dimensional vector spaces.

D1=Distance calculated using Lp Norm for the output of the i-th layer of the Clean AI models (M1, M2). (Example:)

$$Lp ( outM 1 [ i ] - outM 2 [ i ] ) \sqrt{Lp} ( outM 1 [ i ] * Lp ( outM 2 [ i ]$$

Method step 205 comprises calculating a distance D2 using Lp norm between the first set of secondary outputs and the set of primary outputs by means of the processor (20).

D2=Distance calculated using Lp Norm for the output of the i-th layer of the first clean AI model and the trained AI. (Example:)

$$Lp ( outM 1 [ i ] - outM [ i ] ) \sqrt{Lp} ( outM 1 [ i ] * Lp ( outM [ i ]$$

Method step 206 comprises calculating a distance D3 using Lp norm between the second set of secondary outputs and the set of primary outputs by means of the processor (20).

D3=Distance calculated using Lp Norm for the output of the i-th layer of the second clean AI model and the trained AI. (Example:)

$$Lp ( outM 2 [ i ] - outM [ i ] ) \sqrt{Lp} ( outM 2 [ i ] * Lp ( outM [ i ]$$

Method step 207 comprises performing an analysis on the calculated distances D1, D2, D3 by means of the processor (20) to detect poisoning of the AI Model. The steps 204,205,206 are repeated multiple times and the processor (20) takes the mean of distances for n inputs. We compare the distance between all 3 models using a rule-based decision. The processor (20) is further configured to compute a set ratios for mean of distances (D1,D2,D3) and compare it to a pre-defined threshold (T) to perform the analysis.

If ((Mean distance D2/Mean distance D1)<T and (Mean distance D2/Mean distance D1)>1/T) or

((Mean distance D3/Mean distance D1)<T and (Mean distance D3/Mean distance D1)>1/T), we conclude that trained model (M) is not poisoned else we say it is poisoned.

It must be understood that the invention in particular discloses methodology used for poisoning of an AI model. While these methodologies describes only a series of steps to accomplish the objectives, these methodologies are implemented in the system (100), which may be a combination of hardware or software or a combination thereof. Further the embodiments explained in the above detailed description are only illustrative and do not limit the scope of this invention. Any modification to the system (100) and method for detecting poisoning of a trained AI model (M) form a part of this invention. The scope of this invention is limited only by the claims.

1. A method to detect poisoning of a trained AI model, comprising:
training at least two clean AI models having the same architecture as the trained AI model using a non-manipulated dataset;
feeding a manipulated dataset as input to the trained AI model by way of a processor to get a set of primary outputs for each layer of the trained AI model;
feeding the manipulated dataset as input to the at least two clean AI models by way of the processor to get a first set of secondary outputs and a second set of secondary outputs respectively for each layer of the two clean AI models;
calculating a distance D1 using Lp norm between the first set of secondary outputs and the second set of secondary outputs by way of the processor;
calculating a distance D2 using Lp norm between the first set of secondary outputs and the set of primary outputs by way of the processor;
calculating a distance D3 using Lp norm between the second set of secondary outputs and the set of primary outputs by way of the processor; and
performing an analysis on the calculated distances D1, D2, D3 by way of the processor (20) to detect poisoning of the AI Model.

2. The method as claimed in claim 1, wherein the trained AI model (M) and the at least two AI models have the same set of layers.

3. The method as claimed in claim 1, wherein performing the analysis further comprises computing a set ratios for mean of distances (D1, D2, D3) and comparing it to a pre-defined threshold.

4. A system to detect poisoning of a trained AI model, comprising the trained AI model, a processor and at least two clean AI models, said clean AI models being trained on a non-poisonous dataset, and said clean AI models having the same architecture as the trained AI model, wherein the processor is configured to:
feed a manipulated dataset as input to the trained AI model to get a set of primary outputs for each layer of the AI Model;
feed the manipulated dataset as input to the at least two clean AI models to get a first set of secondary outputs and a second set of secondary outputs respectively for each layer of the two clean AI models respectively;
calculate a distance D1 using Lp norm between the first set of secondary outputs and the second set of secondary outputs;
calculate a distance D2 using Lp norm between the first set of secondary outputs and the set of primary outputs;
calculate a distance D3 using Lp norm between the second set of secondary outputs and the set of primary outputs; and
perform an analysis on the calculated distances D1, D2, D3 to detect poisoning of the AI Model.

5. The system as claimed in claim 4, wherein the trained AI model (M) and the at least two AI models have the same set of layers, identical connection between the layers and the same set of hyperparameters.

6. The system as claimed in claim 4, wherein the processor is further configured to compute a set ratios for mean of distances (D1, D2, D3) and compare it to a pre-defined threshold to perform the analysis.
